(19) United States
(12) Patent Application Publication
(10) Pub. No.: US 2008/0125127 A1
(43) Pub. Date: May 29, 2008

(54) Apparatus and method for handover in broadband wireless communication system

(75) Inventor: Seon-Goo Hwang, Gwangmyeong-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 11/998,271

(22) Filed: Nov. 29, 2007

(30) Foreign Application Priority Data
Nov. 29, 2006 (KR) 2006-118736

(51) Int. Cl. H04Q 7/20

(52) U.S. Cl. 455/436

(57) ABSTRACT

Provided is an apparatus and method for performing a handover in a broadband wireless communication system. In a method for a handover operation of a mobile station in a broadband wireless communication system, the mobile station determines a value of a forced switching timer in consideration of the time to receive a fast ranging information message. The mobile station generates a handover request message containing the forced switching timer value, and transmits the handover request message to a serving base station, and drives the forced switching timer. The mobile station receives a fast ranging information message from a target base station by switching to the target base station upon termination of the forced switching timer.

### CROSS-REFERENCE TO RELATED APPLICATION(S) AND CLAIM OF PRIORITY

This application claims priority under 35 U.S.C. §119 to an application entitled filed in the Korean Intellectual Property Office on Nov. 29, 2006 and allocated Serial No. 2006-118736, the contents of which are incorporated herein by reference.

### TECHNICAL FIELD OF THE INVENTION

The present invention relates generally to an apparatus and method for a handover in a broadband wireless communication system, and in particular, to an apparatus and method for performing a handover in a broadband wireless communication system by using a timer capable of predicting a fast ranging point.

### BACKGROUND OF THE INVENTION

Extensive research is being conducted on a handover scheme suitable for the high-speed movement of a mobile station in a broadband wireless communication system. The handover scheme can provide a seamless service to a mobile station even when the mobile station moves from a serving base station to another base station.

FIGS. 1A and 1B are flow diagrams illustrating normal handover procedures in a conventional broadband wireless communication system.

FIG. 1A illustrates an exemplary case where a mobile station (MS) 100 moving to a target base station (BS) 130 performs a handover procedure by transmitting a ranging request (RNG-REQ) message 107 to the target BS 130 using Code Division Multiple Access (CDMA) code ranging 104. FIG. 1B illustrates another exemplary case where an MS 100 performs a handover procedure by switching to a target BS 130, receiving a fast ranging information (Fast_Ranging_IE) message 123 from the target BS 130 and transmitting an RNG-REQ message 124 to the target BS 130. The fast ranging is a scheme that directly transmits the RNG-REQ message to the target BS 130 using uplink resources allocated through the fast ranging information message received from the target BS 130, without performing the CDMA code ranging process.

Referring to FIG. 1A, the MS 100, which is to move to the target BS 130 when the signal strength of a serving BS 120 decreases below a reference value, transmits a handover request (MOB_MSHO-REQ) message 101 containing information about candidate base stations to the serving BS 120. In response to the MOB_MSHO-REQ message, the serving BS 120 transmits a handover response (MOB_BSHO-RSP) message 102 containing information about candidate base stations to the MS 100. After determination of the target BS 130, the MS 100 transmits a handover indication (MOB_HO-IND) message 103 to the serving BS 120 and moves (switches) to the target BS 130 (step 109).

Herein, the MOB_MSHO-REQ message 101 is a MAC protocol message containing neighbor BS information detected by the MS 100 in order to perform a handover to the target BS 130, which is transmitted by the MS 100 at the initial handover stage. The MOB_BSHO-RSP message 102 is a MAC protocol message containing candidate base station (BS) information, which is transmitted by the serving BS 120 in response to the MOB_MSHO-REQ message of the MS 100. The MOB_HO-IND message 103 is a MAC protocol message containing information about the target BS 130 to which the MS 100 will switch. The serving BS 120 is a base station that is providing a service to the MS 100. The target BS 130 is a base station to which the MS 100 is handed over. The candidate base stations are base stations, except the serving station, which satisfy the requirements for the target BS 130.

Thereafter, in order to be allocated uplink resources for transmission of RNG-REQ message, the MS 100 performs CDMA code ranging 104 to the target BS 130. The target BS 130 transmits, to the MS 100, an RNG-RSP (Success) message 105 for informing the success of the CDMA code ranging 104 and a code allocation information (CDMA_Allocation_IE) message 106 containing uplink resource allocation information for transmission of an RNG-REQ message 107. The MS 100 transmits the RNG-REQ message 107 to the target BS 130 by using uplink resources allocated through the code allocation information message 106. Upon receipt of the RNG-REQ message 107, the target BS 130 transmits an RNG-RSP message 108 to the MS 100.

Referring to FIG. 1B, the MS 100 transmits an MOB_MSHO-REQ message 120 to a serving BS 120. In response to the MOB_MSHO-REQ message 120, the serving BS 120 transmits an MOB_BSHO-RSP message 121 to the MS 100. Using action time information contained in the MOB_BSHO-RSP message 121 received from the serving BS 120, the MS 100 detects the time when a fast ranging information message is transmitted from the target BS 130.

Thereafter, in the action time 126, the MS 100 switches to the target BS 130 and receives a fast ranging information (Fast_Ranging_IE) message 123 containing information about allocated uplink resources from the target BS 130. Upon receipt of the fast ranging information message 123, the MS 100 transmits an RNG-REQ message 124 using the fast ranging information message 123 and receives an RNG-RSP message 125 from the target BS 130, thereby performing a handover process. It can be seen that the handover processing time of the FIG. 1B handover procedure is shorter by a handover latency gain 131 than that of the FIG. 1A handover procedure.

However, when the MS 100 moves in a handover region during the service period, signal degradation occurs due to signal overlap. In this case, there is a high possibility that MAC messages may be lost between the MS 100 and the serving BS 120. The problem resulting from the loss of the MAC messages will be described with reference to FIG. 2. Referring to FIG. 2, when an MS 200 fails to receive an MOB_BSHO-RSP message 202 from a serving BS 220 due to channel degradation, it cannot know the time when a fast ranging information message is transmitted from a target BS 230. Therefore, the MS 200 cannot receive the fast ranging information message from the target BS 230 and thus cannot perform a fast ranging process. In this case, a handover processing delay occurs as in FIG. 1A because the MS 200 tries to transmit an RNG-REQ message to the target BS 230 through a CDMA code ranging process 204 as illustrated in FIG. 2.

What is therefore required is an apparatus and method for enabling the mobile station to normally receive the fast ranging information message from the target base station even when the MOB_BSHO-RSP message containing the action time information is lost between the mobile station and the serving base station.

### SUMMARY OF THE INVENTION

To address the above-discussed deficiencies of the prior art, it is a primary object of the present invention to provide an apparatus and method for a handover in a broadband wireless communication system.

Another object of the present invention is to provide an apparatus and method for enabling a mobile station (MS) to normally receive a Fast_Ranging_IE message from a target base station (BS) even when an MOB_BSHO-RSP message is lost between the mobile station and a serving base station.

Still another object of the present invention is to provide an apparatus and method for performing a handover in a broadband wireless communication system by use of a timer capable of predicting the time to receive a Fast_Ranging_IE message.

According to one aspect of the present invention, a method for a handover operation of a mobile station in a broadband wireless communication system includes: determining a value of a forced switching timer in consideration of the time to receive a fast ranging information message; generating a handover request message containing the forced switching timer value, transmitting the handover request message to a serving base station, and driving the forced switching timer; and receiving a fast ranging information message from a target base station by switching to the target base station upon termination of the forced switching timer.

According to another aspect of the present invention, a method for performing a handover in a broadband wireless communication system includes: determining a value of a forced switching timer in consideration of the time to receive a fast ranging information message, transmitting a handover request message containing the forced switching timer value to a serving base station, and driving the forced switching timer; receiving the handover request message containing the forced switching timer value and transmitting a timer message containing information of a mobile station and the forced switching timer value to at least one candidate base station; and receiving the timer message from the serving base station, driving the forced switching timer, and generating and transmitting a fast ranging information message to the mobile station upon termination of the forced switching timer.

According to still another aspect of the present invention, an apparatus of a mobile station for a handover in a broadband wireless communication system includes: a timer for determining a value of a forced switching timer in consideration of the time to receive a fast ranging information message; a message generator for generating a handover request message containing the forced switching timer value; and a transmitter for transmitting the handover request message to a serving base station.

According to even another aspect of the present invention, an apparatus for performing a handover in a broadband wireless communication system includes: a mobile station for determining a value of a forced switching timer in consideration of the time to receive a fast ranging information message, transmitting a handover request message containing the forced switching timer value to a serving base station, and driving the forced switching timer; a serving base station for receiving the handover request message containing the forced switching timer value and transmitting a timer message containing information of the mobile station and the forced switching timer value to at least one candidate base station; and a candidate base station for receiving the timer message from the serving base station, driving the forced switching timer, and generating and transmitting a fast ranging information message to the mobile station upon termination of the forced switching timer.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B are flow diagrams illustrating handover procedures in a conventional broadband wireless communication system;

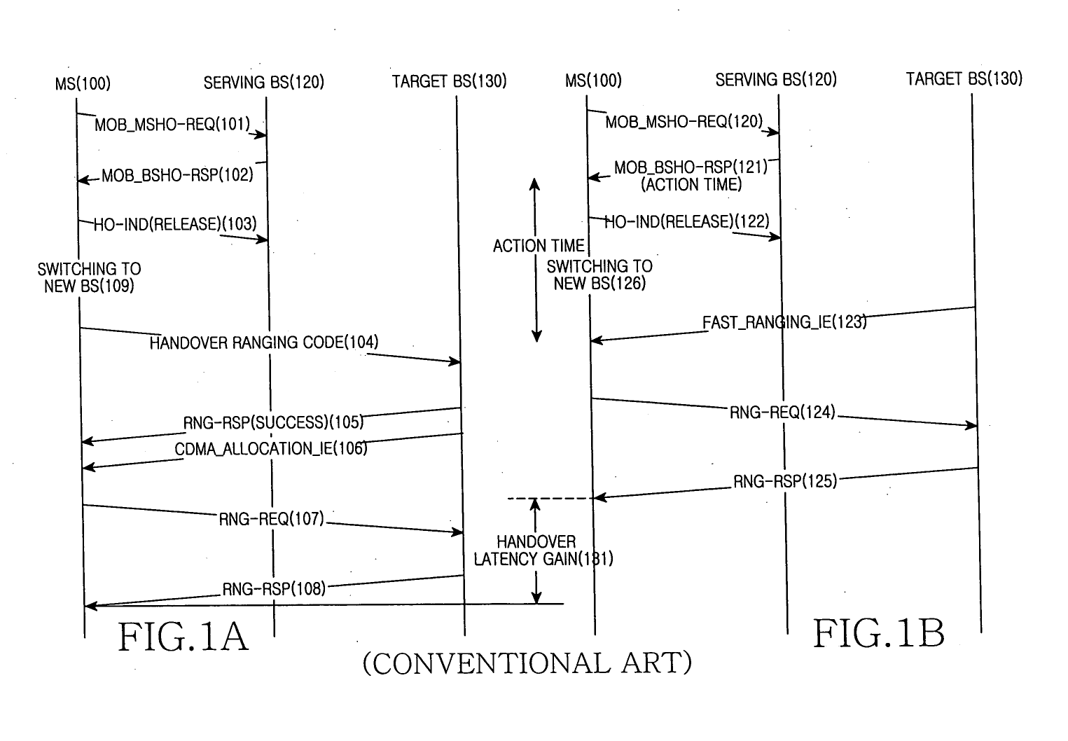

FIG. 2 is a flow diagram illustrating a handover procedure in the conventional broadband wireless communication system in case of failing to receive a handover control message;

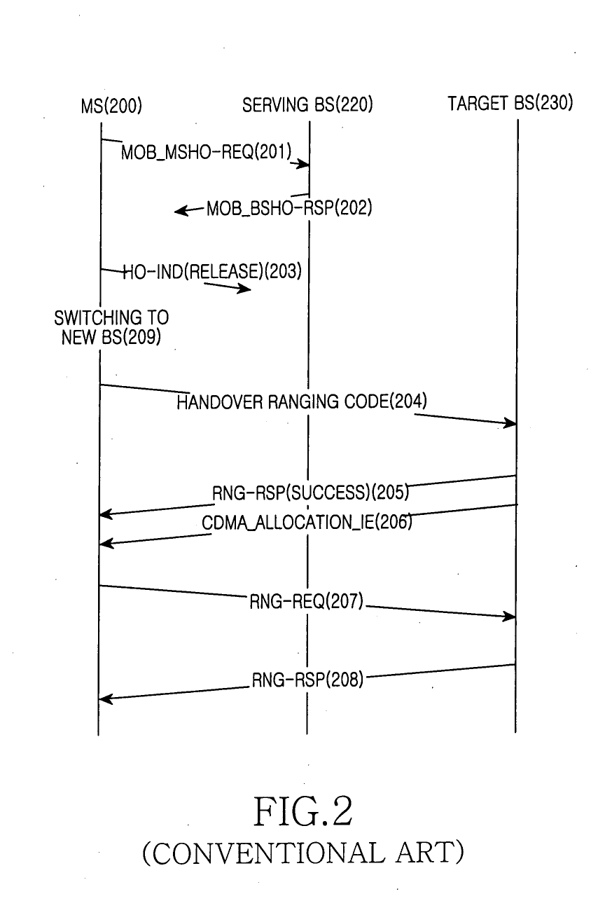

FIG. 3 is a flow diagram illustrating a handover procedure in a broadband wireless communication system according to an embodiment of the present invention;

FIG. 4 is a flow diagram illustrating a handover procedure in a broadband wireless communication system according to an embodiment of the present invention in case of failing to transmit a handover control message to an MS;

FIG. 5 is a block diagram of an MS in a broadband wireless communication system according to an embodiment of the present invention;

FIG. 6 is a block diagram of a BS in a broadband wireless communication system according to an embodiment of the present invention;

FIG. 7 is a flowchart illustrating a handover operation of an MS in a broadband wireless communication system according to an embodiment of the present invention; and

FIG. 8 is a flowchart illustrating a handover operation of a BS in a broadband wireless communication system according to an embodiment of the present invention.

### DETAILED DESCRIPTION OF THE INVENTION

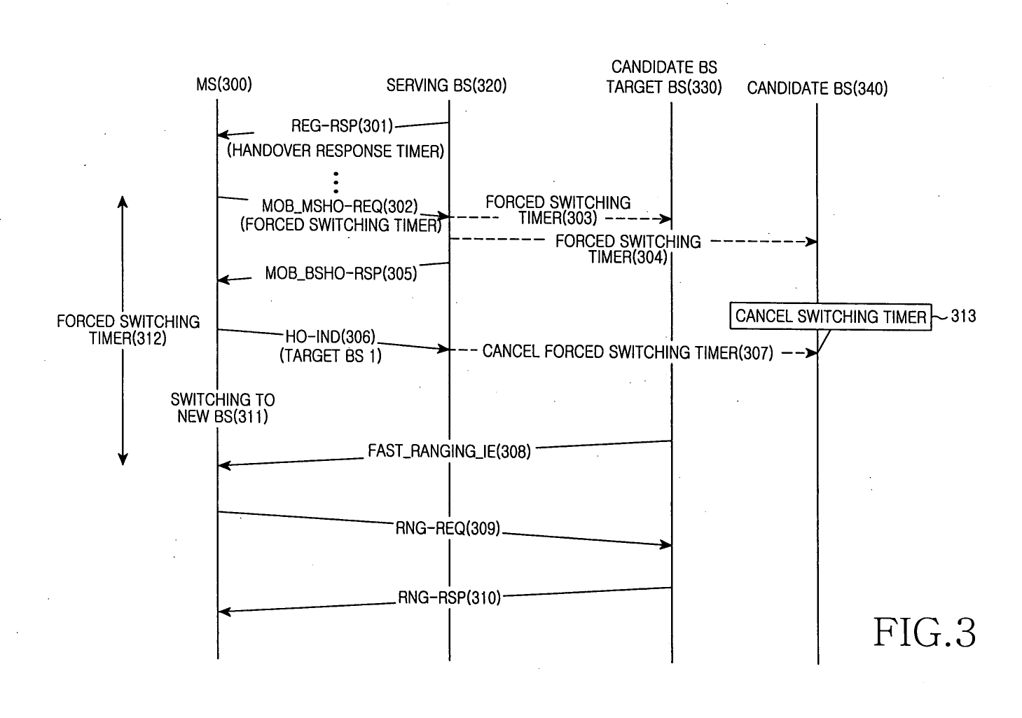

FIGS. 3 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention is intended to provide an apparatus and method for performing a fast ranging handover in a broadband wireless communication system by enabling a mobile station to normally receive a fast ranging information (Fast_Ranging_IE) message from a target base station (BS) even when a handover control message (e.g., MOB_BSHO-RSP) is lost between the mobile station and a serving base station (BS).

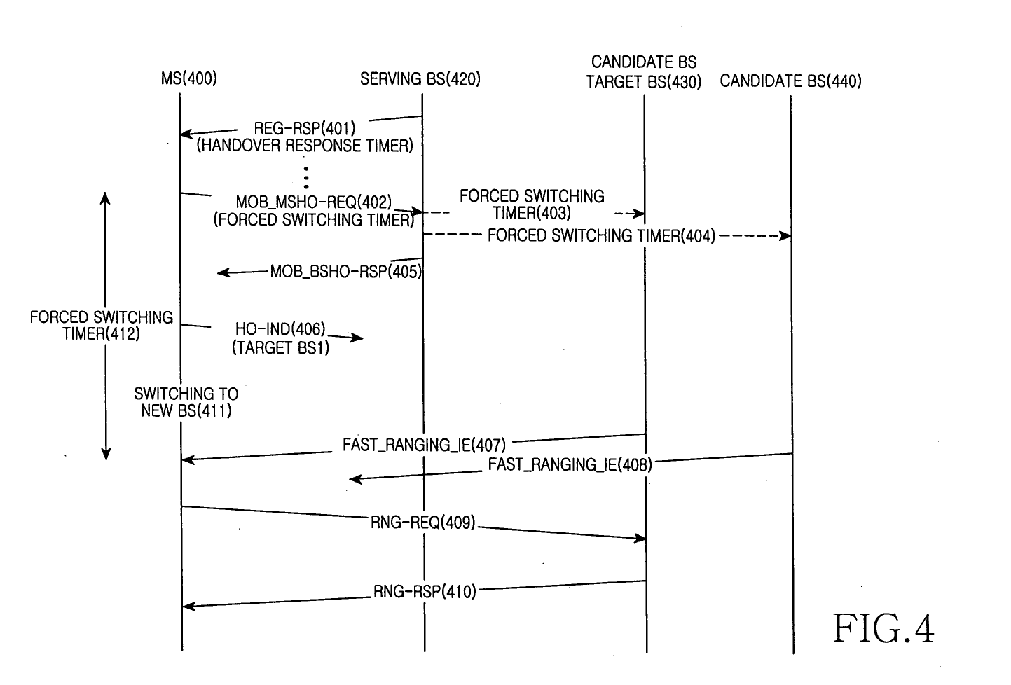

FIGS. 3 and 4 are flow diagrams illustrating handover procedures in a broadband wireless communication system according to an embodiment of the present invention. An initial registration process between a serving base station (BS) and a mobile station (MS) is not illustrated in FIGS. 3 and 4, and it is assumed that the MS has normally completed initial registration in the serving BS.

FIG. 3 is a flow diagram illustrating a normal handover procedure in a broadband wireless communication system according to an embodiment of the present invention.

Referring to FIG. 3, in an initial registration process for a mobile station (MS) 300, a serving base station (BS) 320 transmits a registration response (REG-RSP) message 301 containing a handover response timer value to the MS 300. The handover response timer value is a time period from the time when the serving BS 320 receives an MOB_MSHO-REQ message 302 from the MS 300 to the time when the serving BS 320 transmits an MOB_BSHO-RSP message 305 to the MS 300, which is determined in units of frames.

The handover response timer value is added into an REG-RSP message in a Type/Length/Value (TLV) encoding scheme (11.7.13.x Handover Response Timer in IEEE 802.16e-2005), which is constructed as Table 1 below.

TABLE 1

| Type | Length | Value | Scope |
|---|---|---|---|
| 1 | 2 | Minimum processing time from reception of | REG-RSP |
| | | MOB_MSHO-REQ to transmission of | |
| | | MOB_BSHO-RSP at the serving BS | |
| | | [in frames, minimum value is 1] | |

When a handover is required due to a decrease in the signal strength of the serving BS 320 and an increase in the signal strengths of candidate base stations 330 and 340, the MS 300 determines forced switching timer values 312, 303 and 304 in consideration of the handover response timer value received from the serving BS 320. The forced switching timer value 312/303/304 is a time period from the time when the MS 300 transmits the MOB_MSHO-REQ message 302 to the time when the MS 300 can receive a fast ranging information (Fast_Ranging_IE) message 308 by switching to the candidate BS 330/340, which is determined in units of frames.

The forced switching timer value is added into an MOB_MSHO-REQ message in a TLV encoding scheme (11.15.x Forced Switching Timer in IEEE 802.16e-2005), which is constructed as Table 2 below.

TABLE 2

| Type | Length | Value | Scope |
|---|---|---|---|
| 1 | 2 | Minimum time from transmission | MOB_MSHO-REQ |
| | | of MOB_MSHO-REQ at the | |
| | | serving BS until proper reception | |
| | | of Fast_Ranging_IE at the target | |
| | | BS [in frames, value is greater than | |
| | | Recommended BS Response | |
| | | Timer] | |

The forced switching timer value 312/303/304 set by the MS 300 is the sum of the handover response timer value contained in the REG-RSP message 301, the time taken for the MS 300 to receive the MOB_BSHO-RSP message 305 and transmit an MOB_HO-IND message 306, and the timetaken for the MS 300 to switch to the candidate BS 330 determined as the target BS by the MS 300, which is determined as Equation 1:

Forced_{—}BS_Switching_Time>Recommended_{—}BS_Response_Time+α+β. [Eqn. 1]

In Equation 1, Forced_BS_Switching_Time denotes a forced switching time, Recommended_BS_Response_Time denotes a handover response time, α denotes a time period from the time to receive the MOB_BSHO-RSP message 305 to the time to transmit the MOB_HO-IND message 306, and β denotes a time period from the time to receive the MOB_HO-IND message 306 to the time to demodulate the DL_MAP message of the target BS. Herein, α and β may be different for each MS, depending on the time taken for the MS to process the related message and the time taken for the MS to switch to the target BS.

Thereafter, in order to inform the start of a handover, the MS 300 transmits the MOB_MSHO-REQ message 302 containing the forced switching timer value determined by Equation 1 to the serving BS 320. After transmission of the MOB_MSHO-REQ message 302, the MS 300 drives the forced switching timer 312.

Upon receipt of the MOB_MSHO-REQ message 302 containing the forced switching timer value, the serving BS 320 transmits a message 303/304 containing the forced switching timer value and information about the MS 300 to the candidate BS 330/340. Thereafter, the serving BS 320 transmits the MOB_BSHO-RSP message 305 to the MS 300. The candidate BS 330/340 drives the forced switching timer 303/304 according to the message 303/304 containing the forced switching timer value and the information about the MS 300. Upon termination of the forced switching timer 303/304, the candidate BS 330/340 transmits a fast ranging information (Fast_Ranging_IE) message 308 to the MS 300.

Upon receipt of the MOB_BSHO-RSP message 305 from the serving BS 320, the MS 300 selects the target BS 330 and transmits an MOB_HO-IND message 306 containing the related information to the serving BS 320. Upon receipt of the MOB_HO-IND message 306, based on the information about the target BS 330 in the MOB_HO-IND message 306, the serving BS 320 transmits a forced switching timer cancel message 307 to the candidate BS 340 but does not transmit the forced switching timer cancel message 307 to the target BS 330. Upon receipt of the forced switching timer cancel message 307, the candidate BS 340 cancels (stops) the forced switching timer (step 313) and does not transmit the fast ranging information message to the MS 300. On the other hand, the target BS 330 transmits the fast ranging information message 308 to the MS 300 when the forced switching timer terminates. Alternatively, the target BS 330 may transmit the fast ranging information message 308 to the MS 300 by receiving a signal message from the serving BS 320, before the forced switching timer terminates.

Thereafter, when the forced switching timer 312 terminates, the MS 300 switches to the target BS 330 and waits to receive the fast ranging information message 308. Alternatively, the MS 300 may switch to the target BS 330 immediately after the transmission of the MOB_HO-IND message 306, independently of the termination of the forced switching timer 312.

Upon receipt of the fast ranging information message 308 from the target BS 330, the MS 300 transmits an RNG-REQ message 309 to the target BS 330 using allocated uplink resources. In response to the RNG-REQ message 309 from the MS 300, the target BS 330 an RNG-RSP message 310 to the MS 300.

FIG. 4 is a flow diagram illustrating a handover procedure in a broadband wireless communication system according to an embodiment of the present invention in case of failing to transmit a handover control message to a mobile station. A detailed description of the overlap of the FIG. 4 handover procedure with the FIG. 3 handover procedure will be omitted for conciseness.

Referring to FIG. 4, a mobile station (MS) 400 transmits an MOB_MSHO-REQ message 402 containing a forced switching timer value to a serving base station (BS) 420. Upon receipt of the MOB_MSHO-REQ message 402, the serving BS 420 transmits a message containing a value of a forced switching timer 412 to candidate base stations 430 and 440. Thereafter, the serving BS 420 transmits an MOB_BSHO-RSP message 405 to the MS 400.

However, the MS 400 fails to receive the MOB BSHO-RSP message 405 due to the degradation of a wireless channel. Thus, the MS 400 fails to transmit an MOB_HO-IND message 406 to the serving BS 420.

In this case, because the MS 400 is already informed of the value of the forced switching timer 412, it can predict the time to transmit a fast ranging information message 407/408 from the candidate BS 430/440.

Thus, upon termination of the forced switching timer 412 driven at the transmission of the MOB_MSHO-REQ message 402, the MS 400 switches to the target BS 430 (among the candidate base stations 430 and 440) and waits to receive the fast ranging information message 407.

The candidate BS 430/440, which fails to receive a forced switching timer cancel message from the serving BS 420, drives a forced switching timer 403/404 received from the serving BS 420 and transmits the fast ranging information message 407/408 to the MS 400 upon termination of the corresponding timer. At this point, the MS 400 receives not both of the fast ranging information messages 407 and 408 transmitted from the candidate base stations 430 and 440, but only the fast ranging information message 407 transmitted from the target BS 430.

Using uplink resources allocated through the fast ranging information message 407 received from the target BS 430, the MS 400 transmits an RNG-REQ message to the target BS 430. Thereafter, the MS 400 receives an RNG-RSP message 410 from the target BS 430.

Thus, even when failing to receive a handover control message (e.g., MOB_BSHO-RSP) from the serving BS 420, the MS 400 can perform a fast ranging handover using the forced switching timer 412.

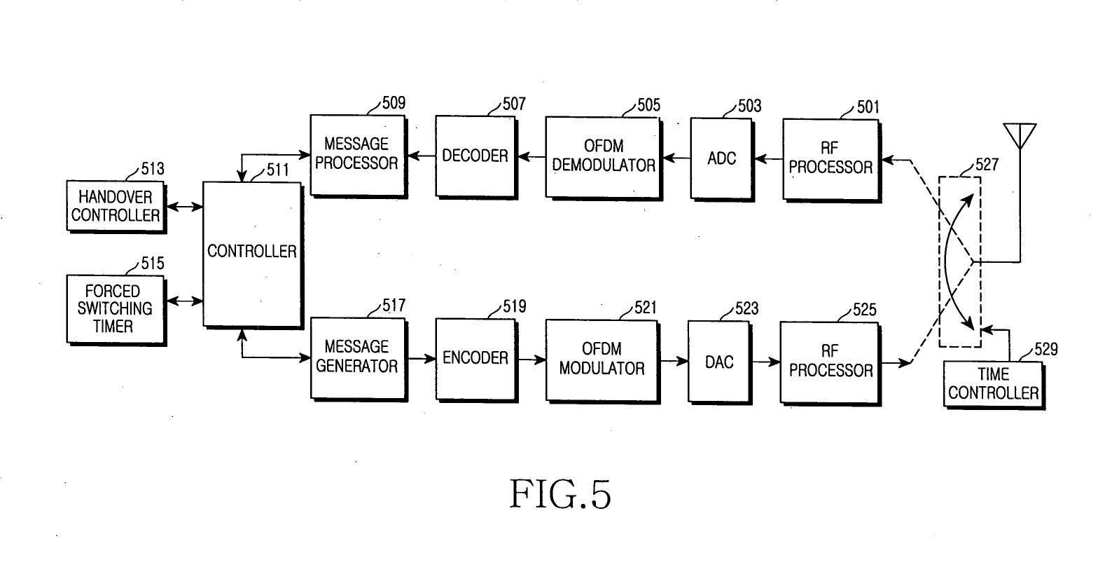

FIG. 5 is a block diagram of a mobile station (MS) for a handover in a broadband wireless communication system according to an embodiment of the present invention.

Referring to FIG. 5, the mobile station includes a receive (RX) radio frequency (RF) processor 501, an analog-to-digital converter (ADC) 503, an Orthogonal Frequency Division Multiplexing (OFDM) demodulator 505, a decoder 507, a message processor 509, a controller 511, a handover controller 513, a forced switching timer 515, a message generator 517, an encoder 519, an OFDM modulator 521, a digital-to-analog converter (DAC) 523, a transmit (TX) RF processor 525, a switch 527, and a time controller 529.

The time controller 529 controls a switching operation of the switch 527 based on frame synchronization. For example, in a receive (RX) period, the time controller 529 controls the switch 527 so that an antenna is connected to the RX RF processor 501. In a transmit (TX) period, the time controller 529 controls the switch 527 so that the antenna is connected to the TX RF processor 525.

In the RX period, the RX RF processor 501 converts an RF signal received through the antenna into a baseband analog signal. The ADC 503 converts the analog signal received from the RX RF processor 501 into sample data (i.e., a digital signal). The OFDM demodulator 505 performs Fast Fourier Transform (FFT) on the sample data received from the ADC 503 to output frequency-domain data.

The decoder 507 selects data of desired subcarriers from the frequency-domain data received from the OFDM demodulator 505, and demodulates and decodes the selected data in accordance with a predetermined Modulation and Coding Scheme (MCS) level.

The message processor 509 analyzes a control message received from the decoder 507 and provides the analysis results to the controller 511. According to the present invention, the message processor 509 detects a handover response timer value for a fast ranging handover from a handover control message (e.g., a REQ_RSP message) received from the serving BS 320/420, and provides the detected handover response timer value to the forced switching timer 515. Also, the message processor 509 analyzes a handover response (MOB_BSHO-RSP) message, a ranging response (RNG-RSP) message, and a fast ranging information (Fast_Ranging_IE) message, and provides the analysis results to the handover controller 513 through the controller 511.

The controller 511 performs processing according to the information received from the message processor 509 and provides the processing results to the message generator 517. Under the control of the controller 511, the handover controller 513 generates and manages handover related information. For example, the handover controller 513 determines a serving BS and a target BS among candidate base stations and performs a control operation of transmitting a handover request (MOB_MSHO-REQ) message containing a forced switching timer value received from the forced switching timer 515 to the serving BS. Also, the handover controller 513 performs a control operation of transmitting an MOB_HO-IND message containing handover cancel or rejection information and a ranging request (RNG-REQ) message to the serving BS. Also, the handover controller 513 controls the MS to switch to the target BS to receive a fast ranging information (Fast_Ranging_IE) message, upon termination of the forced switching timer after transmission of the MOB_MSHO-REQ message. Also, the handover controller 513 performs a control operation of receiving the handover response (MOB_BSHO-RSP) message, the ranging response (RNG-RSP) message, and the fast ranging information (Fast_Ranging_IE) message.

Under the control of the controller 511, the forced switching timer 515 calculates a forced switching timer value using the handover response timer value and provides the forced switching timer value to the handover controller 513 through the controller 511. For example, as expressed in Equation (1), the forced switching timer value is determined as the sum of the handover response timer value contained in an REG-RSP message, the time taken for the MS to receive an MOB_BSHO-RSP message and transmit an MOB_HO-IND message, and the time taken for the MS to switch to the target BS in order to receive a fast ranging information message from the target BS.

The message generator 517 generates a message using various data received from the controller 511 and provides the generated message to the encoder 519 of a physical layer. For example, the message generator 517 generates the MOB_MSHO-REQ message containing the forced switching timer value, the MOB_HO-IND message containing the handover cancel/rejection information, and the RNG-REQ message for the ranging request and provides the generated messages to the encoder 519.

The encoder 519 encodes and modulates data received from the message generator 517 in accordance with a predetermined MCS level. The OFDM modulator 521 Inverse Fast Fourier Transform (IFFT)-processes data received from the encoder 519 to output sample data (OFDM symbols). The DAC 523 converts the sample data into an analog signal. The TX RF processor 525 converts the analog signal received from the DAC 523 into an RF signal and transmits the RF signal through the antenna.

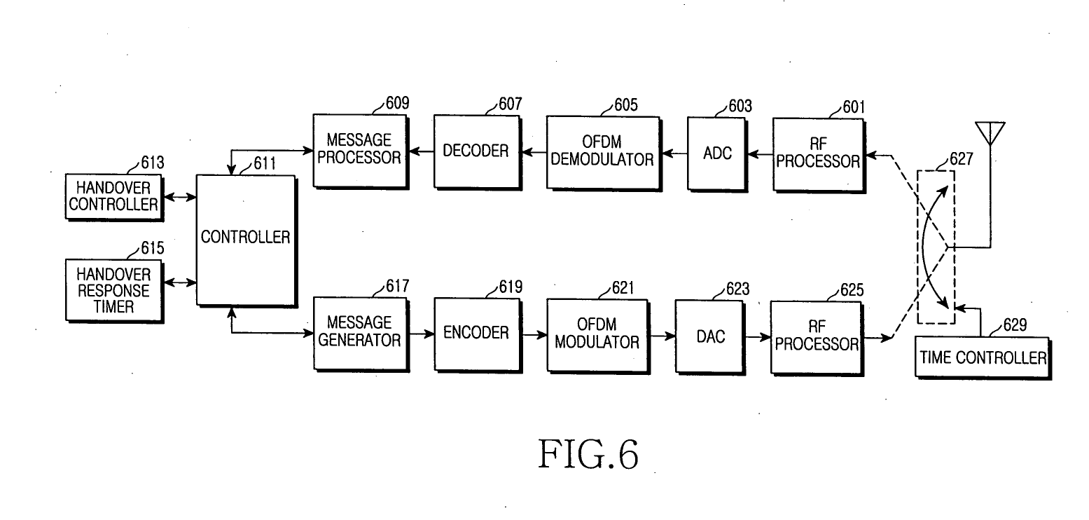

FIG. 6 is a block diagram of a base station (BS) for a handover in a broadband wireless communication system according to an embodiment of the present invention.

Referring to FIG. 6, the BS includes a receive (RX) radio frequency (RF) processor 601, an ADC 603, an OFDM demodulator 605, a decoder 607, a message processor 609, a controller 611, a handover controller 613, a handover response timer 615, a message generator 617, an encoder 619, an OFDM modulator 621, a DAC 623, a transmit (TX) RF processor 625, a switch 627, and a time controller 629.

The time controller 629 controls a switching operation of the switch 627 based on frame synchronization. For example, in an RX period, the time controller 629 controls the switch 627 so that an antenna is connected to the RX RF processor 601. In a TX period, the time controller 629 controls the switch 627 so that the antenna is connected to the TX RF processor 625.

In the RX period, the RX RF processor 601 converts an RF signal received through the antenna into a baseband analog signal. The ADC 603 converts the analog signal received from the RX RF processor 601 into sample data (i.e., a digital signal). The OFDM demodulator 605 FFT-processes the sample data received from the ADC 603 to output frequency-domain data.

The decoder 607 selects data of desired subcarriers from the frequency-domain data received from the OFDM demodulator 605, and demodulates/decodes the selected data in accordance with a predetermined MCS level.

The message processor 609 analyzes a control message received from the decoder 607 and provides the analysis results to the controller 611. For example, in the case of a serving BS, the message processor 609 detects a forced switching timer value contained in an MOB_MSHO-REQ message received from the MS and provides the detected switching timer value to the handover controller 613 through the controller 611.

The controller 611 performs processing according to the information received from the message processor 609 and provides the processing results to the handover controller 613. Also, the controller 611 controls a registration process (e.g., REG-RSP) to transmit an REG-RSP message containing a handover response timer value to the MS.

Under the control of the controller 611, the handover controller 613 generates and manages handover related information. For example, in the case of the serving BS, the handover controller 613 performs a control operation of transmitting a message containing the forced switching timer value and information about the MS to the candidate BS upon receipt of an MOB_MSHO-REQ message from the message processor 609. Also, the handover controller performs a control operation of transmitting an MOB_BSHO-RSP message containing the candidate BS information received from the MS to the MS. In the case of the target BS or the candidate BS, the handover controller 613 performs a control operation of transmitting a fast ranging information message to the MS after termination of the forced switching timer upon receipt of a message containing information about the MS and the forced switching timer value from the message processor 609. In the case of the candidate BS, the handover controller 613 performs a control operation of terminating the forced switching timer upon receipt of a forced switching timer cancel message from the message processor 609, so that the fast ranging information message is not transmitted to the MS.

The message generator 617 generates a message using various data received from the controller 611 and provides the generated message to the encoder 619 of a physical layer. For example, in the case of the serving BS, the message generator 617 generates a message containing the forced switching timer value and information about the MS, which will be transmitted to the candidate BS. Also, the message generator 617 generates an handover response (MOB_BSHO-RSP) message and an REG-RSP message containing a handover response timer value, which will be transmitted to the MS. In the case of the target BS or the candidate BS, the message generator 617 generates the fast ranging information message when the forced switching timer terminates. However, if the message processor 609 receives the forced switching timer cancel message, the message generator 617 does not generate the fast ranging information message.

The encoder 619 encodes and modulates data received from the message generator 617 in accordance with a predetermined MCS level. The OFDM modulator 621 IFFT-processes data received from the encoder 619 to output sample data (OFDM symbols). The DAC 623 converts the sample data into an analog signal. The TX RF processor 625 converts the analog signal received from the DAC 623 into an RF signal and transmits the RF signal through the antenna.

In the above-described configurations of FIGS. 5 and 6, the controller controls the message processor, the message generator, the handover controller, and the forced switching timer. The controller can perform the functions of the message processor, the message generator, the handover controller, and the forced switching timer. Although separate units are provided for respective functions of the controller, the controller can perform all or some of the functions instead of such separate units.

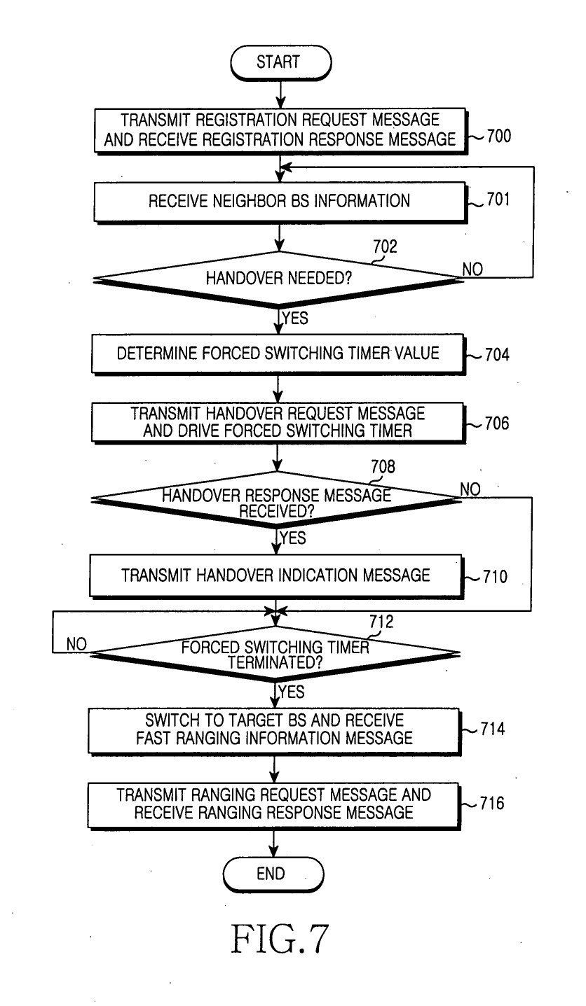

FIG. 7 is a flowchart illustrating a handover operation of a mobile station (MS) in a broadband wireless communication system according to an embodiment of the present invention.

Referring to FIG. 7, an MS 300/400 first performs a registration process for initial entry or reentry into a target BS 330/430. In step 700, the MS 300/400 transmits a registration request (REG-REQ) message for a handover or a network reentry, and receives a registration response (REG-RSP) message from a serving BS 320/420 to detect handover response timer information that indicates a message round-trip time between the MS and the serving BS.

In step 701, the MS receives information about neighbor base stations (hereinafter referred to as neighbor BS information) from the serving BS. For example, the MS receives the neighbor BS information by receiving a broadcast message from the serving BS periodically or at need.

In step 702, the MS determines the need or not of a handover to the target BS on the basis of the signal strength of the serving BS. For example, if the signal strength of the serving BS decreases below a reference value, the MS starts the handover. If the handover is needed, the MS proceeds to step 704; and if not, the MS returns to step 701.

In step 704, the MS determines a forced switching timer value in order to perform a fast ranging handover independently of the receipt or not of an MOB_BSHO-RSP message.

In step 706, the MS transmits an MOB_MSHO-REQ message containing the forced switching timer value to the serving BS and drives the forced switching timer. The forced switching timer is driven so that the MS can receive a fast ranging information message by switching to the target BS upon termination of the forced switching timer, even when the MS fails to receive the MOB_BSHO-RSP message from the serving BS.

In step 708, the MS determines if the handover response (MOB_BSHO-RSP) message is received. If the MOB_BSHO-RSP message is received, the MS proceeds to step 710; and if not, the MS proceeds directly to step 712. In step 710, the MS transmits an MOB_HO-IND message to the serving BS. In step 712, the MS determines if the forced switching timer is terminated.

If the forced switching timer is not terminated (in step 712), the MS repeats step 712 until the forced switching timer is terminated.

If the forced switching timer is terminated (in step 712), the MS proceeds to step 714. In step 714, the MS switches to the target BS and receives a fast ranging information message.

In step 716, the MS transmits a ranging request (RNG-REQ) message to the target BS and receives a ranging response (RNG-RSP) message from the target BS.

A handover response timer value transmitted from the serving BS to the target BS may be changed by re-negotiation with the MS through REG-REQ or REG-RSP, if it is different from that used in the target BS.

Thereafter, the MS ends the fast ranging handover procedure of the present invention.

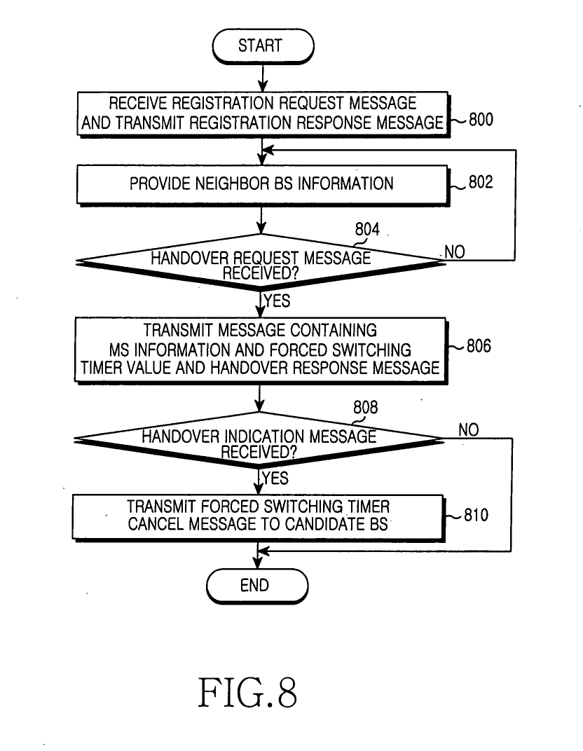

FIG. 8 is a flowchart illustrating a handover operation of a base station (BS) in a broadband wireless communication system according to an embodiment of the present invention.

Referring to FIG. 8, in step 800, a serving BS receives an REG-REQ message from an MS. Thereafter, the BS calculates a handover response timer value. The handover response timer value is a time period from the time when the MS transmits an MOB_MSHO-REQ message to the time when the MS can receive a fast ranging information message by switching to a candidate BS. For example, the BS may determine the handover response timer value by calculating an average message transmission time through a ranging, negotiation or authentication process for the MS. Thereafter, the BS transmits an REG-RSP message containing the handover response timer value to the MS.

In step 802, using a broadcast message, the serving BS provides neighbor BS information to the MS. In step 804, the serving BS determines if an MOB_MSHO-REQ message containing a forced switching timer value is received. If the MOB_MSHO-REQ message is not received (in step 804), the serving BS returns to step 802.

If the MOB_MSHO-REQ message is received (in step 804), the serving BS proceeds to step 806. In step 806, the serving BS transmits a message containing information about the MS and the forced switching timer value to candidate base stations and transmits an MOB_BSHO-RSP message to the MS. Upon receipt of the message containing the information about the MS and the forced switching timer value, each of the candidate base stations drives the forced switching timer and transmits a fast ranging information message to the MS by use of the MS information upon termination of the forced switching timer.

In step 808, the serving BS determines if an MOB_HO-IND message is received. If the MOB_HO-IND message is not received (in step 808), the serving BS immediately ends the fast ranging handover procedure of the present invention. If the MOB_HO-IND message is received (in step 808), the serving BS proceeds to step 810. In step 810, the serving BS transmits a forced switching timer cancel message to the candidate BS (except the target BS). Upon receipt of transmits the forced switching timer cancel message, the candidate BS (except the target BS) terminates the forced switching timer and does not transmit the fast ranging information message to the MS.

Thereafter, the serving BS ends the fast ranging handover procedure of the present invention.

As described above, the present invention enables the MS to normally receive the Fast_Ranging_IE message from the target BS even when the MOB_BSHO-RSP message is lost between the MS and the serving BS due to the degradation of channel conditions. Therefore, the handover processing time can be minimized. Also, the MS can efficiently receive the Fast_Ranging_IE message from the target BS by considering the message processing time that may vary depending on the performance of the MS.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for a handover operation of a mobile station in a broadband wireless communication system, the method comprising:
determining a value of a forced switching timer in consideration of the time to receive a fast ranging information message;
generating a handover request message containing the forced switching timer value, transmitting the handover request message to a serving base station, and driving the forced switching timer; and
receiving a fast ranging information message from a target base station by switching to the target base station upon termination of the forced switching timer.

2. The method of claim 1, further comprising transmitting a handover indication message containing information about the target base station upon receipt of a handover response message for the handover request message.

3. The method of claim 1, wherein the forced switching timer value is a time period from the time to transmit the handover request message to the time to receive the fast ranging information message from the target base station.

4. The method of claim 1, wherein the forced switching timer value is the sum of the time taken to receive the handover response message after the transmission of the handover request message, the time taken to transmit the handover indication message after the receipt of the handover response message, and the time taken to switch to the target base station in order to receive the fast ranging information message.

5. The method of claim 4, wherein information about the time taken to receive the handover response message after the transmission of the handover request message is obtained from a registration response message received from the base station.

6. The method of claim 1, further comprising, upon receipt of the fast ranging information message, transmitting a ranging request message to the target base station and receiving a ranging response message for the ranging request message from the target base station.

7. A method for performing a handover in a broadband wireless communication system, the method comprising:
determining a value of a forced switching timer in consideration of the time to receive a fast ranging information message, transmitting a handover request message containing the forced switching timer value to a serving base station, and driving the forced switching timer;
receiving the handover request message containing the forced switching timer value and transmitting a timer message containing information of a mobile station and the forced switching timer value to at least one candidate base station; and
receiving the timer message from the serving base station, driving the forced switching timer, and generating and transmitting a fast ranging information message to the mobile station upon termination of the forced switching timer.

8. The method of claim 7, further comprising, upon receipt of a handover indication message containing information about a target base station from the mobile station, transmitting a forced switching timer cancel message to the candidate base station except the target base station.

9. The method of claim 7, further comprising receiving a fast ranging information message at the mobile station by switching to a target base station upon termination of the forced switching timer.

10. The method of claim 7, further comprising transmitting a registration response message containing a handover response timer value to the mobile station before the receipt of the handover request message.

11. The method of claim 10, wherein the handover response timer value is determined using an average round-trip time of handover request/response messages.

12. The method of claim 7, wherein if a forced switching timer cancel message is received from a neighbor base station during the operation of the forced switching timer, the forced switching timer is terminated to cancel the transmission of the fast ranging information message.

13. The method of claim 7, further comprising, upon receipt of the fast ranging information message, transmitting a ranging request message to a target base station and receiving a ranging response message for the ranging request message from the target base station.

14. An apparatus of a mobile station for a handover in a broadband wireless communication system, the apparatus comprising:
a timer for determining a value of a forced switching timer in consideration of the time to receive a fast ranging information message;
a message generator for generating a handover request message containing the forced switching timer value; and
a transmitter for transmitting the handover request message to a serving base station.

15. The apparatus of claim 14, further comprising a handover controller for driving the forced switching timer when transmitting the handover request message, and receiving a fast ranging information message from a target base station by switching to the target base station upon termination of the forced switching timer.

16. The apparatus of claim 14, wherein the message generator generates and transmits a handover indication message containing information about a target base station upon receipt of a handover response message for the handover request message.

17. The apparatus of claim 14, wherein the forced switching timer value is the sum of the time taken to receive a handover response message after the transmission of the handover request message, the time taken to transmit a handover indication message after the receipt of the handover response message, and the time taken to switch to a target base station in order to receive the fast ranging information message.

18. The apparatus of claim 17, wherein information about the time taken to receive the handover response message after the transmission of the handover request message is obtained from a registration response message received from the base station.

19. The apparatus of claim 15, wherein upon receipt of the fast ranging information message, the handover controller performs a fast ranging process for the target base station by using information contained in the received fast ranging information message.

20. A broadband wireless communication system for performing a handover, the system comprising:
a mobile station for determining a value of a forced switching timer in consideration of the time to receive a fast ranging information message, transmitting a handover request message containing the forced switching timer value to a serving base station, and driving the forced switching timer;
a serving base station for receiving the handover request message containing the forced switching timer value and transmitting a timer message containing information of the mobile station and the forced switching timer value to at least one candidate base station; and
a candidate base station for receiving the timer message from the serving base station, driving the forced switching timer, and generating and transmitting a fast ranging information message to the mobile station upon termination of the forced switching timer.

21. The system of claim 20, wherein upon receipt of a handover indication message containing information about a target base station from the mobile station, the serving base station transmits a forced switching timer cancel message to the candidate base station except the target base station.

22. The system of claim 20, wherein the mobile station receives a fast ranging information message by switching to a target base station upon termination of the forced switching timer.

23. The system of claim 20, wherein the serving base station transmits a registration response message containing a handover response timer value determined using an average round-trip time of handover request/response messages to the mobile station before the receipt of the handover request message.

24. The system of claim 20, wherein if a forced switching timer cancel message is received from a neighbor base station during the operation of the forced switching timer, the candidate base station terminates the forced switching timer to cancel the transmission of the fast ranging information message.

25. The system of claim 20, wherein upon receipt of the fast ranging information message, the mobile terminal transmits a ranging request message to a target base station and receives a ranging response message for the ranging request message from the target base station.
